(19) United States
(12) Patent Application Publication
(10) Pub. No.: US 2004/0210783 A1
(43) Pub. Date: Oct. 21, 2004

(54) Monitor

(76) Inventors: Min-Jye Chen, Miaoli City (TW); Ting-Hui Chih, Hualien City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/824,567

(22) Filed: Apr. 14, 2004

(30) Foreign Application Priority Data
Apr. 16, 2003 (TW) 092108863

(51) Int. Cl. G06F 1/26

(52) U.S. Cl. 713/300

(57) ABSTRACT

A monitor with a first power port and a power line is connected to a power supply of a computer, so as to acquire direct current (DC) for the monitor to function. One end of the main body of the power line is installed with a first connector while the other end of the main body is installed with a second connector, and the first connector is electrically connected with the second connector via the main body. The power supply of the PC includes a second power port. When the first connector is plugged into the first power port and also the second connector is plugged into the second power port, the first power port can be electrically connected with the second power port via the power line, so as to have the monitor obtain the supply of the DC direct from the power supply of the computer.

This application claims the benefit of Taiwan application Serial No. 092108863, filed Apr. 16, 2003, the subject matter of which is incorporated herein by reference.

### BACKGROUND OF THE INVENTION

1. Field of the Invention

The invention relates in general to a monitor and the power line thereof, and more particularly to a monitor supplied with the direct current (DC) from the power supply of a personal computer (PC).

2. Description of the Related Art

The startling growth of the information and communication industries pushes the fast development of personal computers (PCs). Liquid crystal display (LCD) monitors with PCs are well known and have enjoyed a huge commercial success. LCD monitors rely on the ability of liquid crystal materials to change their optical state in response to an applied voltage exceeding a threshold voltage, resulting in a readily observable change in the appearance of the display.

In case of a LCD monitor, a direct current (DC) voltage of +12 Volt is required in general, so an AC/DC adaptor is further applied in transforming alternating current (AC) into direct current (DC) if the public power system is the main electricity source for the LCD monitor. FIG. 1 is a schematic diagram of a conventional LCD monitor. The LCD monitor 100 is supplied with the DC from the public power system by a conventional AC/DC adaptor, such as an AC/DC adaptor 150 of FIG. 1. The AC/DC adaptor 150 receives the commercial AC power supply of 110V, transforms the AC power supply into a DC voltage of +12 V, and supplies the DC voltage to the LCD monitor 100.

A conventional LCD monitor obtains the supply of the DC by an AC/DC adaptor receiving from the public power system and transforming the AC power supply into a DC voltage of +12 V. Considerations should be given here to LCD monitor manufacturers, the operation of transforming voltage will cause the consumption of the electricity and increase the production cost for manufacturing AC/DC adaptors.

### SUMMARY OF THE INVENTION

In view of the foregoing, it is therefore an object of the invention to provide an improved liquid crystal display (LCD) monitor supplied with the direct current (DC) from the power supply of a personal computer (PC).

Accordingly, the present invention relates to a monitor that includes at least a power line and a first power port. The monitor is connected with a power supply of a computer, so as to acquire a direct current (DC) for the monitor to function. The power line includes a main body. The first end of the main body is installed with a first connector and the second end of the main body is installed with a second connector. The power supply of the computer includes a second power port. When the first connector is plugged into the first power port and the second connector is plugged into the second power port, the first power port is electrically connected with the second power port via the power line, so that the monitor supplied with the direct current (DC) from the power supply of the computer.

Another objective of the present invention is to provide a display system that includes a monitor, a computer and a power line. The monitor includes a first power port; the computer includes a power supply with a second power port. The power line connects the monitor and the power supply of the computer so that the monitor is directly supplied with the direct current (DC) from the power supply. The power line includes a main body, a first connector and a second connector. The first connector is disposed on a first end of the main body, for plugging in the first power port of the monitor. The second connector is disposed on the second end of the main body, for plugging in the second power port of the power supply of the computer. When the first connector is plugged into the first power port and the second connector is plugged into the second power port, the first power port can be electrically connected with the second power port via the power line, so that the monitor is supplied with the direct current (DC) from the power supply of the computer. An add-on card port bracket is further installed in the computer system. The add-on card port bracket includes a hole for receiving the main body so that the main body of the power line penetrates the add-on card port bracket through the hole and electrically connects the monitor and the computer.

Another objective of the present invention is to provide a power line for connecting a monitor and a power supply of a personal computer (PC). The monitor includes a first power port and the power supply of the computer includes a second power port. The power line includes a main body, a first connector and a second connector. The first connector is disposed on the first end of the main body, for plugging in the first power port of the monitor. The second connector is disposed on the second end of the main body, for plugging in the second power port of the power supply of the computer. When the first connector is plugged into the first power port and the second connector is plugged into the second power port, the first power port is electrically connected with the second power port via the power line, so that the monitor is directly supplied with the direct current (DC) from the power supply.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A (Prior Art) is a schematic diagram of a conventional LCD monitor;

FIG. 2A is a schematic diagram of a display system according to the present invention;

FIG. 2B is a conceptual diagram according to FIG. 2A, illustrating that the LCD monitor is connected with the power supply via the power line;

FIG. 3A is a lateral view of the ATX power connector of the power supply;

FIG. 3B is a lateral view of the 5¼-inches power connector of the power supply;

FIG. 3C is a lateral view of the 3½-inches power connector of the power supply;

FIG. 4 is a schematic diagram of the power line with the add-on card port bracket;

FIG. 5A is a schematic diagram showing the power line and the adapter; and

FIG. 5B is a schematic diagram of the power line and the connector adapter connected therewith.

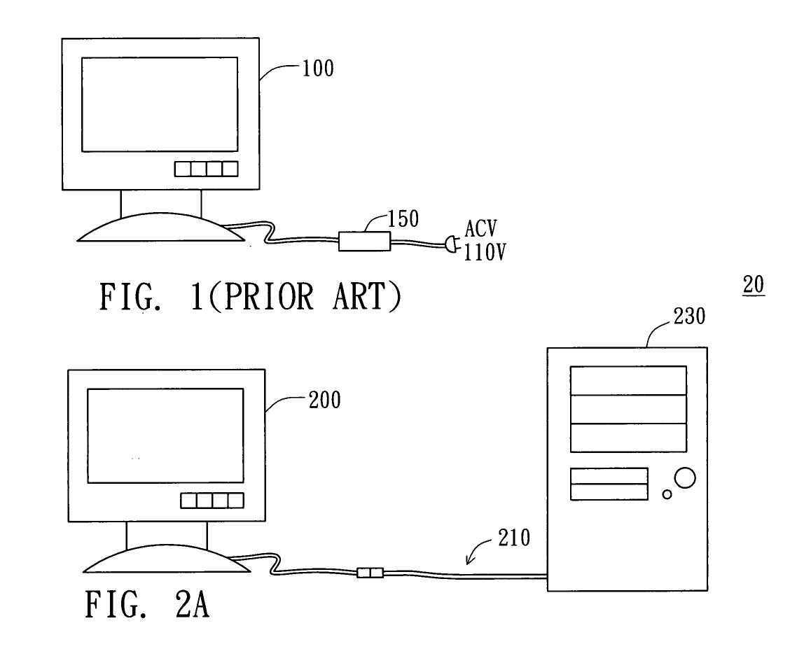

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like components throughout.

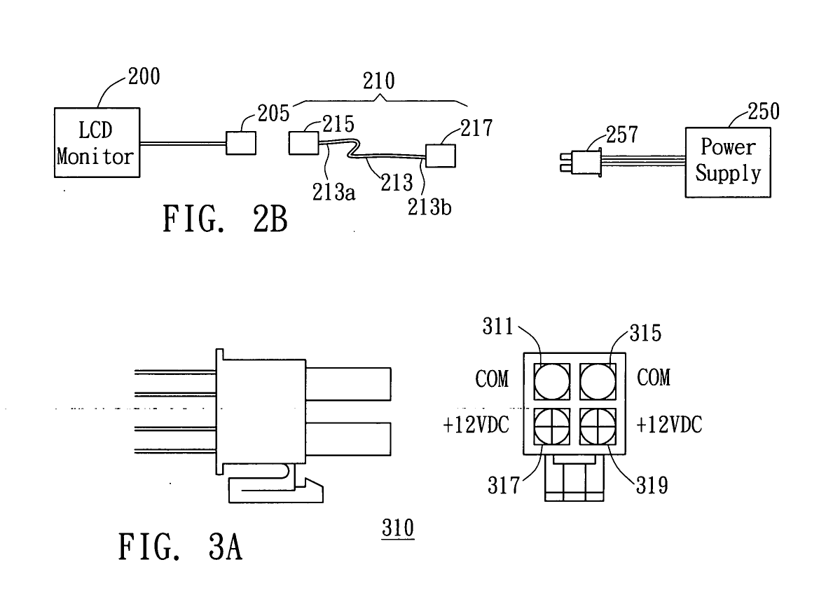

Power supply is essential for personal computer system; it is employed to supply direct current (DC) to devices, such as motherboards, hard disks, CD-ROMs, and fans. The present invention aims to utilize the established power supply instead of the alternating current (AC) of the public power system as the power source of the monitor. With reference to FIG. 2A, which is a schematic diagram of a display system according to the present invention, the display system 20 includes a displaying device such as a monitor 200 or more particularly an LCD monitor, a computer 230 such as a personal computer (PC) and a power line 210. The monitor 200 is connected to the computer 230 via the power line 210 so that the monitor 200 is supplied with the direct current (DC).

FIG. 2B is a conceptual diagram according to FIG. 2A, illustrating the connection of the monitor and the power supply by using the power line. The PC 230 is equipped with a power supply 250 which has a second power port 257 at one end. The second power port 257 can function as a power outlet. The second power ports 257 with various specifications, such as ATX, RAMBUS, 5¼-inches or 3½-inches power connector, can be applied to adapt to different devices with different specifications: ATX, 5¼-inches and 3½-inches power connectors are all capable of supplying +12 Volt of direct current. As shown in FIG. 2B, the monitor 200 is connected to the power supply 250 via the power line 210. The power line 210 includes a main body 213 and two connectors 215 and 217 at two opposite ends of the main body 213. The connector 215 is disposed at the first end 213a of the main body 213 and the connector 217 is disposed at the second end 213b of the main body 213. The connector 215 is electrically coupled to the connector 217 via the connection of the main body 213. The monitor 200 has a first power port 205, which can function as a power inlet, at one end to be plugged into the connector 215. By plugging the connector 215 and the connector 217 into the first power port 205 and the second power port 257, respectively, the first power port 205 and the second power port 257 are electrically connected. Thus, direct current (DC) from the power supply 250 of the computer 230 can be supplied to the monitor 200.

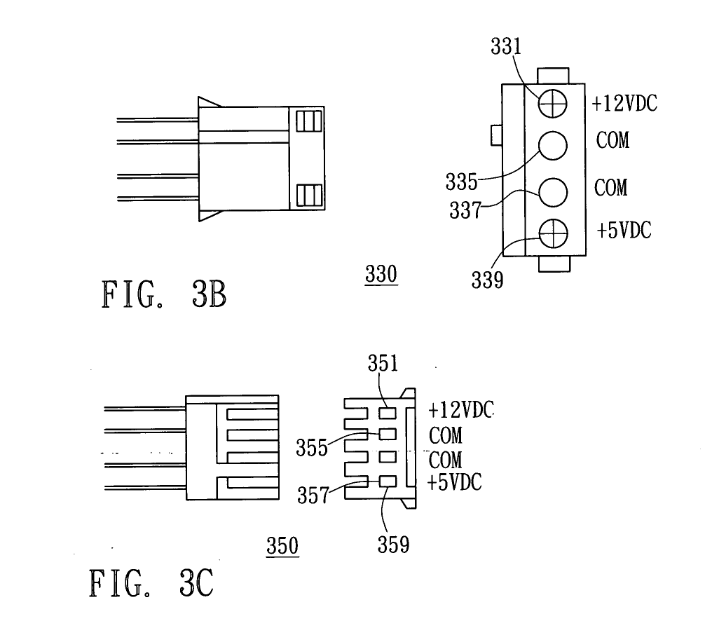

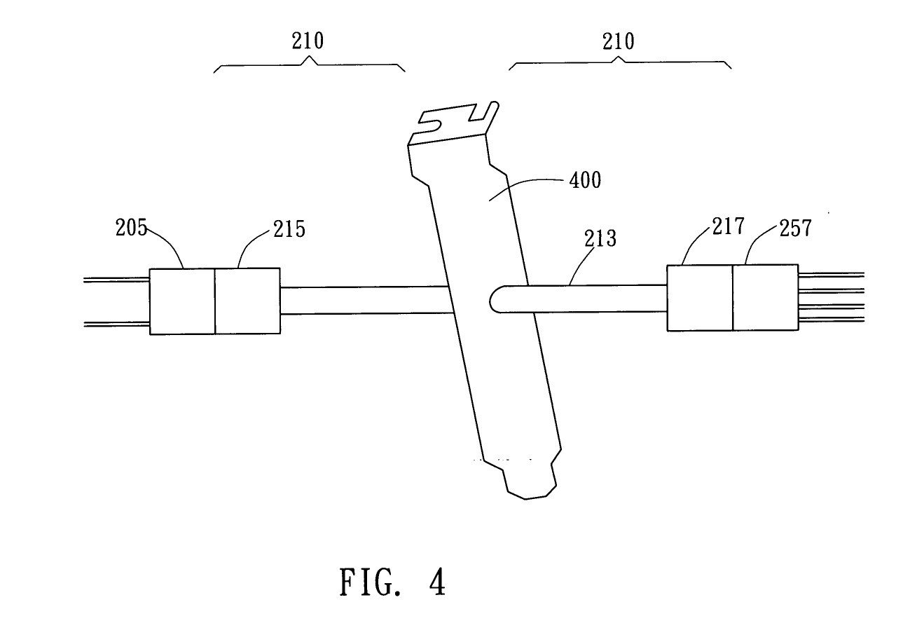

FIG. 3A is a lateral view of the ATX type second power port of the power supply. Referring to FIG. 3A, the ATX type second power port 310 includes two ground wire ends 311 and 315 and two hot wire ends 317 and 319. There is a voltage difference of +12 Volt of direct current between the ground wire ends 311 and the hot wire ends 317, and between the ground wire ends 315 and the hot wire ends 319. The monitor 200 can be therefore supplied with direct current (DC) from the ground wire end 311 and the hot wire end 317 (or the ground wire end 315 and the hot wire end 319) by the connection of the power line 210.

FIG. 3B is a lateral view of the 5¼-inches type second power port of the power supply. Referring to FIG. 3B, the 5¼-inches type second power port 330 includes two hot wire ends 331 and 339 and two ground wire ends 335 and 337. There are a voltage difference of +5 Volt of direct current between the ground wire end 337 and the hot wire end 339, and a voltage difference of +12 Volt of direct current between the ground wire end 335 and the hot wire end 331 so that the monitor 200 is supplied with the direct current (DC) from the ground wire end 335 and the hot wire end 331 by the connection of the power line 210.

FIG. 3C is a lateral view of the 3½-inches type second power port of the power supply. Referring to FIG. 3C, the 3½-inches type second power port 350 includes two hot wire ends 351 and 359 and two ground wire ends 355 and 357. There are a voltage difference of +5 Volt of direct current between the ground wire end 357 and the hot wire end 359 and a voltage difference of +12 Volt of direct current between the ground wire end 355 and the hot wire end 351 so that the monitor 200 is supplied with the direct current (DC) from the ground wire end 355 and the hot wire end 351 by the connection of the power line 210.

The power line 210 is preferably equipped with an add-on card port bracket between connectors 215 and 217 to facilitate the plugging of the power line 210 to the second power port of the power supply within the computer. FIG. 4 is a schematic diagram of the power line with the add-on card port bracket. Referring to FIG. 4, the add-on card port bracket 400 is installed in the computer and the add-on card port bracket 400 includes a hole for receiving the main body 231 so that the main body 213 can penetrate the add-on card port bracket 400 through the hole. The assembly process preferably includes the following steps: penetrating the main body 213 through the hole; connecting the connectors 215 and 217 at two opposite ends of the main body 213; plugging the connector 217 into the second power port 257; and screw-fixing the add-on card port bracket 400 at the housing of the computer 230. The connector 215 is therefore exposed rather than embedded inside the housing of the computer 230. While the connector 215 is plugged into the first power port 205, the monitor 200 is supplied with the direct current (DC) from the second power port 257.

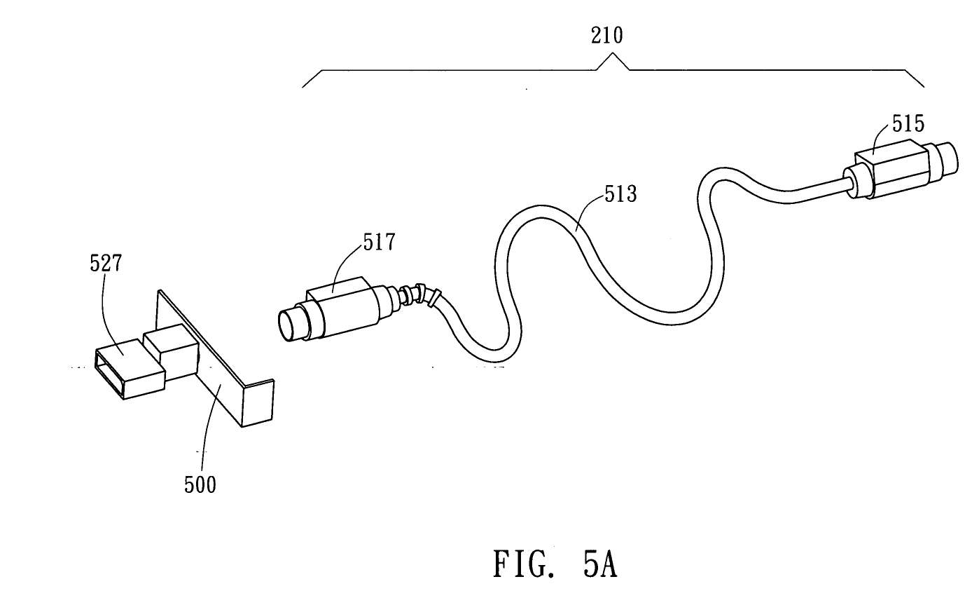

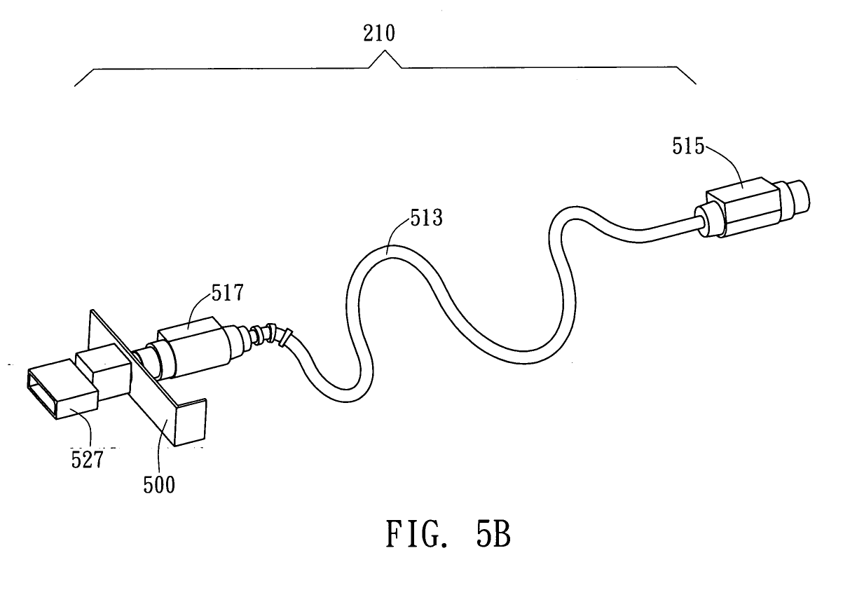

Alternatively, an adapter, serving to connect the power line and the second power port of the power supply, can be further employed on the add-on card port bracket. FIG. 5A is a schematic diagram showing the power line and the adapter. The power line includes a main body 513 and two connectors 515 and 517. The adapter 527 is deposited at the add-on card port bracket 500. While two ends of the adapter 527 are respectively plugged into the connector 517 and the second power port 257 (as shown in FIG. 4) of the power supply 250, the monitor 200 is supplied with the direct current (DC) from the power supply 250, as shown in FIGS. 5B and 2B.

Both referring to FIG. 2B and FIG. 5B, one end, the first end, of the adapter 527 is plugged into the connector 517 and the connector 515 is further plugged into the first power port of the monitor. The other end, the second end, of the adapter 527 is plugged into the second power port of the power supply. Therefore, the monitor is consequently supplied with the direct current (DC) from the power supply 250 via the second power port 257, adapter 527, the add-on card port bracket 500, the connector 517, the main body 513, the connector 515, the first power port 205 to the monitor 200.

In summary, the display system of the present invention at least offers the following advantages:

a. The monitor is supplied with the direct current (DC) directly from the power supply of the computer via the power line so that the production cost is further reduced.

b. The monitor is supplied with the direct current (DC) directly from the power supply of the computer rather than converted from the alternating current (AC) of the public power system. As a result, the waste of electricity conversion is prevented.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A power line for connecting a monitor and a power supply of a computer, the monitor having a first power port, and the power supply having a second power port, the power line comprising:
a main body with a first end and a second end;
a first connector disposed on the first end of the main body; and
a second connector disposed on the second end of the main body,
wherein the monitor is supplied with a direct current (DC) from the power supply of the computer after the first connector is plugged into the first power port of the monitor and the second connector is plugged into the second power port so as to electrically connect the first power port of the monitor with the second power port of the power supply via the power line.

2. The power line according to claim 1, wherein the direct current voltage is 12 Volt.

3. The power line according to claim 1, wherein the first power port of the monitor is a power inlet, and the second power port of the power supply is a power outlet.

4. The power line according to claim 1, wherein the computer comprises an add-on card port bracket with a hole for receiving the main body, so that the power line penetrates the add-on card port bracket through the hole and electrically connects the monitor to the computer.

5. A display system, comprising:
a monitor with a first power port;
a computer having a power supply with a second power port; and
a power line for connecting the monitor and the power supply of the computer so as to supply the monitor a direct current (DC) from the power supply, the power line comprising:
a main body having a first end and a second end;
a first connector disposed on the first end of the main body; and
a second connector disposed on the second end of the main body,
wherein the monitor is supplied with the direct current (DC) from the power supply of the computer after the first connector is plugged into the first power port of the monitor and the second connector is plugged into the second power port so as to electrically connect the first power port of the monitor with the second power port of the power supply via the power line.

6. The display system according to claim 5, wherein the computer comprises an add-on card port bracket with a hole for receiving the main body, so that the power line penetrates the add-on card port bracket through the hole and electrically connects the monitor to the computer.

7. The display system according to claim 5, wherein the direct current voltage is 12 Volt.

8. The display system according to claim 5, wherein the first power port of the monitor is a power inlet, and the second power port of the power supply of the computer is a power outlet.

9. A monitor connected with a power supply of a computer, the monitor comprising:
a first power port; and
a power line for connecting the computer and the monitor, the power supply having a second power outlet, and the power line comprising:
a main body with a first end and a second end;
a first connector disposed on the first end of the main body to connect with the first power port of the monitor; and
a second connector disposed on the second end of the main body to connect with the second power port of the computer,
wherein the monitor is supplied with a direct current (DC) from the power supply of the computer after the first connector is plugged into the first power port of the monitor and the second connector is plugged into the second power port so as to electrically connect the first power port of the monitor with the second power port of the power supply via the power line.

10. The monitor according to claim 9, wherein the direct current voltage is 12 Volt.

11. The monitor according to claim 9, wherein the first power port of the monitor is a power inlet, and the second power port of the power supply of the computer is a power outlet.

12. The monitor according to claim 9, wherein the computer comprises an add-on card port bracket with a hole for receiving the main body, so that the power line penetrates the add-on card port bracket through the hole and electrically connects the monitor to the computer.
